(19) United States
(12) Patent Application Publication
(10) Pub. No.: US 2019/0093958 A1
(43) Pub. Date: Mar. 28, 2019

(54) COOLING MEMBER AND POWER STORAGE MODULE

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventors: Hideyuki KUBOKI, Yokkaichi-shi, Mie (JP); Hiroki HIRAI, Yokkaichi-shi, Mie (JP); Makoto HIGASHIKOZONO, Yokkaichi-shi, Mie (JP); Akihisa HOSOE, Osaka-shi, Osaka (JP); Yoshiyuki HIROSE, Osaka-shi, Osaka (JP); Tomoharu TAKEYAMA, Osaka-shi, Osaka (JP); Eiichi KOBAYASHI, Osaka-shi, Osaka (JP)

(21) Appl. No.: 16/084,873

(22) PCT Filed: Mar. 9, 2017
(86) PCT No.: PCT/JP2017/009433

§ 371 Date: Sep. 13, 2018

(30) Foreign Application Priority Data
Mar. 16, 2016 (JP) 2016-052322

(51) Int. Cl. F28D 15/04; H01G 11/18; H01M 10/613; H01M 10/6552; H01M 10/6556; H01M 10/6569

(52) U.S. Cl. CPC F28D 15/046; H01G 11/18; H01M 10/6569; H01M 10/6552; H01M 10/6556; H01M 10/613

(57) ABSTRACT

A cooling member includes an enclosing member including sheet members connected in a liquid tight manner and including small compartments, refrigerant enclosed in each of the small compartments, and an absorbing member arranged in each of the small compartments and absorbing the refrigerant. Each of the small compartments includes a condensation section where the refrigerant that is in a gaseous state is condensed.

### CROSS REFERENCE TO RELATED APPLICATIONS

This application claims the priority of Japanese patent application JP2016-052322 filed on Mar. 16, 2016, the entire contents of which are incorporated herein. cl TECHNICAL FIELD

The technology described in this specification relates to a cooling member and a power storage module.

### BACKGROUND ART

A cooling member (such as a heat pipe) described in Patent Document 1 (Japanese Unexamined Patent Application Publication No. 11-23169) has been known. Such a heat pipe includes a pipe made of metal and heat transfer fluid that is enclosed in the pipe in a liquid tight manner.

According to the above configuration, the pipe is required to be strong to have the heat transfer fluid therein. If the heat transfer fluid receives heat from heat generator and is evaporated, a volume of the heat transfer fluid increases and pressure within the pipe increases. A manufacturing cost is increased to enclose the heat transfer fluid within the pipe in a liquid tight manner and use a pipe having relatively great strength.

As an assumptive technology for solving the above problem, a following cooling member has been proposed. The cooling member may include an enclosing member including sheet members that are connected in a liquid tight manner, refrigerant enclosed in the enclosing member, and an absorbing member arranged in the enclosing member and absorbing the refrigerant. The absorbing member may include an evaporation section where the refrigerant is evaporated and turned into gas and the enclosing member may include a condensation section where the gaseous state refrigerant is condensed and turned into liquid.

According to such an assumptive technology, the liquid state refrigerant absorbed by the absorbing member absorbs heat from the heat source and is evaporated in the evaporation section. The heat from the heat source is absorbed as the heat of vaporization and the temperature of the heat source is decreased. The refrigerant that is turned into gas in the evaporation section moves within the enclosing member and reaches the condensation section. The gaseous state refrigerant is condensed and turned into liquid in the condensation section. The heat of evaporation is released and the released heat is transferred to the sheet member and released to the outside of the cooling member through the outer surface of the sheet member.

The refrigerant that is turned into liquid in the condensation section is absorbed by the absorbing member and moves within the absorbing member and reaches the evaporation section. Then, the above cycle is repeatedly performed.

However, in the above assumptive technology, in a section far away from the condensation section, the refrigerant that is turned into liquid in the condensation section may be evaporated before reaching the section. Then, the absorbing member may be dried in the section far away from the condensation section, and such a section of the absorbing member may not work for cooling the heat source. As a result, the heat source may not be effectively cooled down.

The present technology described in this specification has been completed in view of the circumstances described above. It is an object of the present technology to improve cooling properties of a cooling member.

### SUMMARY

The technology described in this specification is a cooling member including an enclosing member including sheet members connected in a liquid tight manner and including small compartments, refrigerant enclosed in each of the small compartments, and an absorbing member arranged in each of the small compartments and absorbing the refrigerant, and each of the small compartments includes a condensation section where the refrigerant that is in a gaseous state is condensed.

According to the above configuration, the enclosing member is defined into the small compartments and each small compartment includes the condensation section. According to such a configuration, the refrigerant that is condensed in the condensation section and turned into liquid is absorbed by the absorbing member and promptly spreads over a whole absorbing member. As a result, the absorbing member is less likely to have the section that does not include the refrigerant and is dry and the absorbing member is less likely to have the section that does not work for cooling. Accordingly, the cooling efficiency of the cooling member can be improved.

According to the present technology described in this specification, cooling properties of a cooling member can be improved.

### BRIEF DESCRIPTION OF THE DRAWINGS

FIG. 1 is a plan view illustrating two sheet members included in a cooling member according to a first embodiment.

FIG. 2 is a plan view illustrating the two sheet members that are bonded with heat-welding.

FIG. 3 is a plan view illustrating a process of putting an absorbing member into each small compartment.

FIG. 4 is a plan view illustrating the absorbing member.

FIG. 5 is a plan view illustrating a battery module.

FIG. 6 is a plan view illustrating a process of manufacturing an absorbing member according to other embodiment (3).

### MODES FOR CARRYING OUT THE INVENTION

### First Embodiment

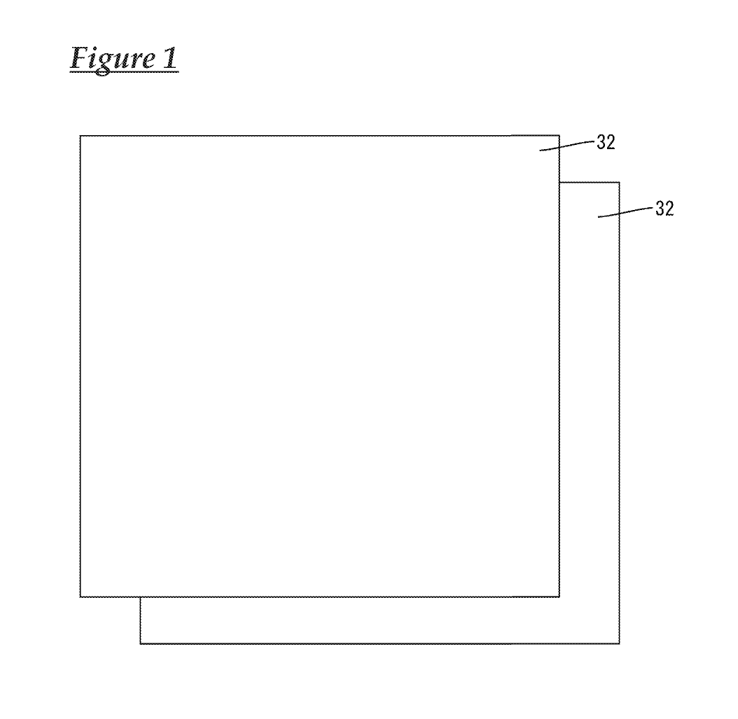

A first embodiment according to a technology described in this specification will be described with reference to FIGS. 1 to 5. A power storage module 10 according to this embodiment includes a power storage element 12, and a cooling member 13 that is arranged to be in contact with a part of an outer surface of the power storage element 12. In the following description, a right side and a lower side in FIGS. 1 to 5 correspond to a right side and a front side, respectively. Symbols or numerals are put on one or some of the parts having the same shape and no symbols or numerals may be put on the rest of them.

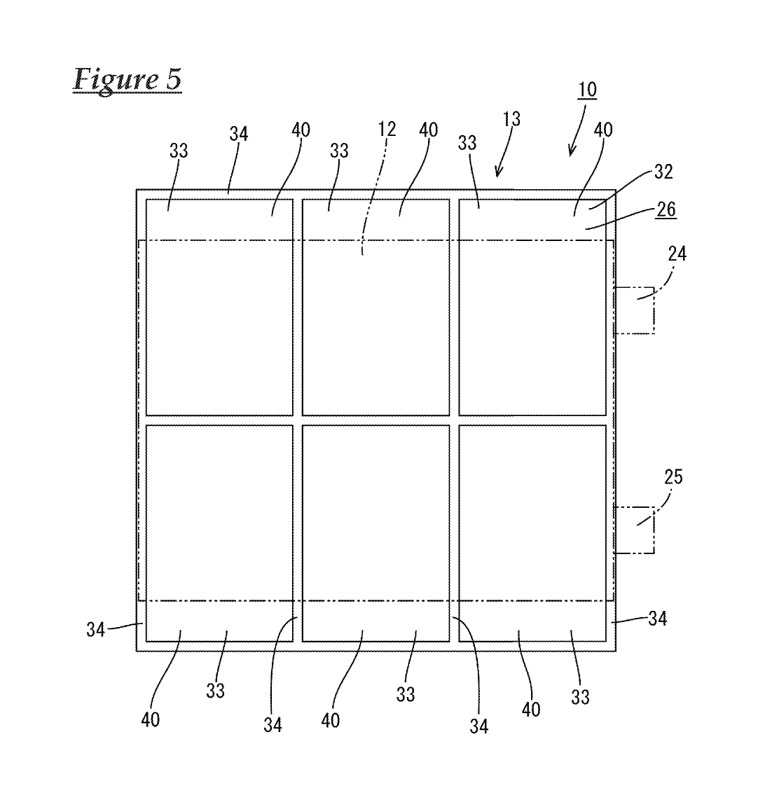

The power storage element 12 includes a pair of battery laminating sheets and a power storage component, which is not illustrated, between the laminating sheets, and edge sections of the battery laminating sheets are bonded in a liquid tight manner with a known method such as heat-welding. As illustrated in FIG. 5, a positive terminal 24 and a negative terminal 25 that are formed of a thin metal foil extend from an inside to an outside of the battery laminating sheets while being in contact with inner surfaces of the battery laminating sheets in a liquid tight manner. The positive terminal 24 and the negative terminal 25 project from a right end of the power storage element 12 and are arranged in a front-rear direction at intervals. The positive terminal 24 and the negative terminal 25 are electrically connected to the power storage components, respectively.

In this embodiment, secondary batteries such as lithium ion secondary batteries and nickel hydride batteries or capacitors such as electric double layer capacitors and lithium ion capacitors may be used as the power storage element 12, and any power storage element 12 can be used as appropriate.

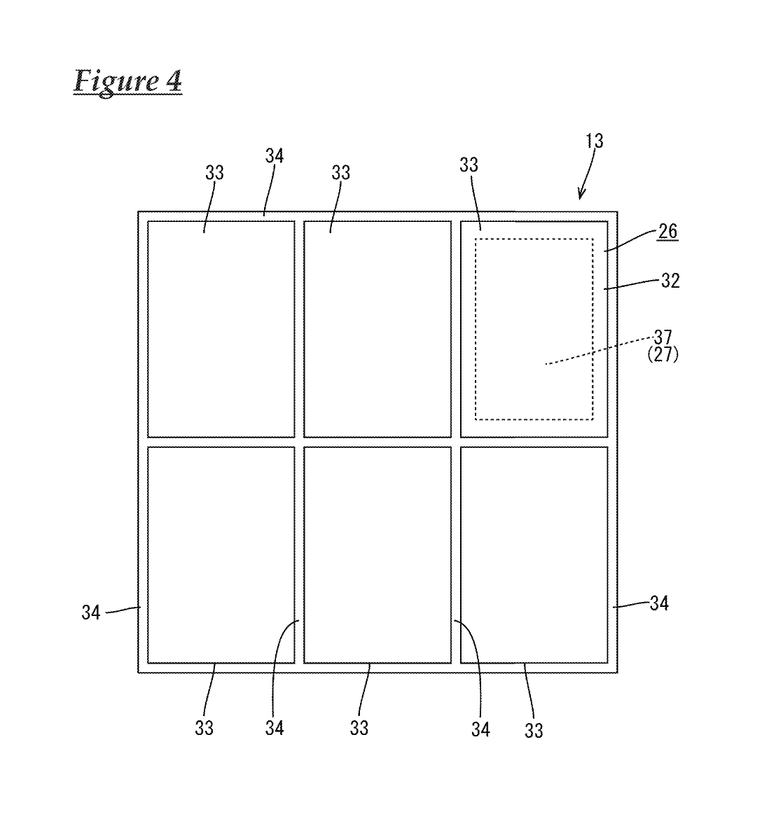

As illustrated in FIG. 4, the cooling member 13 includes refrigerant 27 and an enclosing member 26 that is formed in a liquid tight manner and the refrigerant 27 is enclosed within the enclosing member 26. An amount of the refrigerant 27 enclosed in the enclosing member 26 is determined as appropriate. In this embodiment, the refrigerant 27 is absorbed by an absorbing member 37, which will be described later, and the symbol representing the refrigerant 27 illustrates the absorbing member 37. One or some may be selected from a group of perfluorocarbon, hydrofluoroether, hydrofluoroketone, fluorine inert liquid, water, and alcohol such as methanol and ethanol can be used as the refrigerant 27. The refrigerant 27 may have an insulating property or may have conductivity.

In this embodiment, the cooling member 13 has a length dimension in the front-rear direction that is greater than the length dimension of the power storage element 12. According to such a configuration, the cooling member 13 includes portions projecting frontward and rearward, respectively, from the power storage element 12 disposed on the cooling member 13.

The enclosing member 26 includes two sheet members 32 each having a substantially rectangular shape. The sheet members 32 are overlapped and certain portions of the sheet members 32 are connected in a liquid tight manner with a known method such as bonding, deposition, or welding. The enclosing member 26 includes bonded sections 34 where the sheet members 32 are bonded to each other.

The sheet member 32 includes a metal sheet and a synthetic resin film disposed on a surface of the metal sheet. Any metal such as aluminum, aluminum alloy, copper, or copper alloy may be selected as appropriate as the metal of the metal sheet. Any synthetic resin such as polyolefin such as polyethylene and polypropylene, polyester such as polybutylene terephthalate and polyethylene terephthalate, and polyamide such as nylon 6 and nylon 6, 6 may be selected as appropriate as the synthetic resin of the synthetic resin film.

The enclosing member 26 of this embodiment is obtained by overlapping surfaces of the sheet members 32 having the synthetic resin film thereon and bonding the films with heat-welding.

The enclosing member 26 includes small compartments 33 (six small compartments in this embodiment) while the sheet members 32 being bonded to each other in a liquid tight manner. In this embodiment, two small compartments 33 are formed in the front-rear direction and three small compartments 33 are formed in the right-left direction. Each small compartment 33 is sealed such that front, rear, right, and left edges thereof are sealed in a liquid tight manner. The small compartment 33 has a substantially rectangular shape. Each of the small compartments 33 has a same shape and a same size.

As illustrated in FIG. 5, the portions of the cooling member 13 projecting frontward and rearward from the power storage element 12 are condensation sections 40 where the refrigerant 27 that is in a gaseous state is condensed and changed into liquid with a phase transition. In the condensation section 40, the refrigerant 27 that is in a gaseous state and has relatively high temperature dissipates heat and is changed to liquid with phase transition within the enclosing member 26. The released heat of condensation is transferred to the sheet members 32 and the heat dissipates from the outer surfaces of the sheet members 32 to the outside of the cooling member 13.

In the cooling member 13, front edge portions of the respective three small compartments 33 that are formed on the front side are the condensation sections 40. In the cooling member 13, rear edge portions of the respective three small compartments 33 that are formed on the rear side are the condensation sections 40.

The absorbing member 37 is arranged inside each of the small compartments 33 formed in the enclosing member 26. The absorbing member 37 has a shape slightly smaller than that of the small compartment 33 and is a substantially rectangular sheet.

The absorbing member 37 is made of material that can absorb the refrigerant 27. The absorbing member 37 may be formed of a cloth obtained by processing material that can absorb the refrigerant 27 into fibers or may be formed of a non-woven cloth. Examples of the non-woven cloth may include a fiber sheet, web (a thin film sheet made of only fibers), and batt (fibers of blanket). The material of the absorbing member 37 may be natural fibers or synthetic fibers made of synthetic resin or may include both of the natural fibers and the synthetic fibers.

The absorbing member 37 is preferably prepared as follows. When sixty seconds has elapsed after a lower end portion of the absorbing member 37, which is disposed in a vertical position, is immersed in the refrigerant 27, the refrigerant 27 spreads within the absorbing member 37 such that a distance or a height dimension between an upper end of the refrigerant 27 and a liquid surface of the refrigerant 27 is preferably 5 mm or more. According to such a configuration, the absorbing properties of the refrigerant 27 is improved and cooling properties of the cooling member 13 can be improved.

### (One Example of Manufacturing Process)

Next, one example of the manufacturing process of the power storage module 10 according to this embodiment will be described. The manufacturing process is not limited to that described below.

As illustrated in FIG. 1, two sheet members 32 are overlapped such that the synthetic films that are disposed on the respective sheet members 32 are opposite each other.

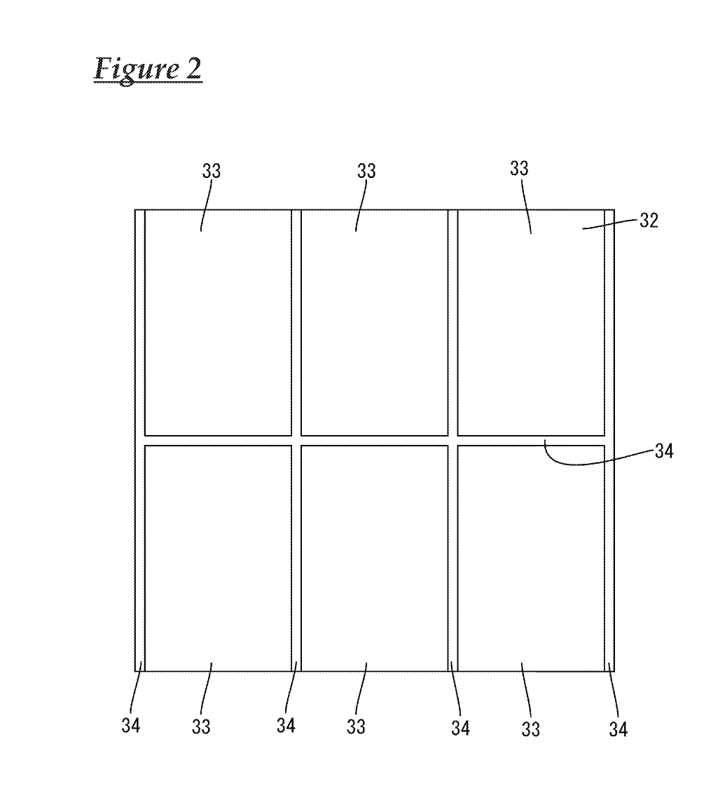

Next, as illustrated in FIG. 2, the certain portions of the sheet members 32 are bonded with heat-welding. In this embodiment, the bonded section 34 extending in the right-left direction is formed in a substantially middle of the sheet members 32 with respect to the front-rear direction. The bonded sections 34 are formed to divide the sheet members 32 into three sections with respect to the right-left direction and formed at right and left edges of the sheet members 32. Four bonded sections 34 in total extending in the front-rear direction are formed with heat-welding.

According to the above process, six small compartments 33 are defined. In this state, the three small compartments 33 at the front side of the sheet members 32 have front edges that are open, and the three small compartments 33 at the rear side of the sheet members 32 have rear edges that are open.

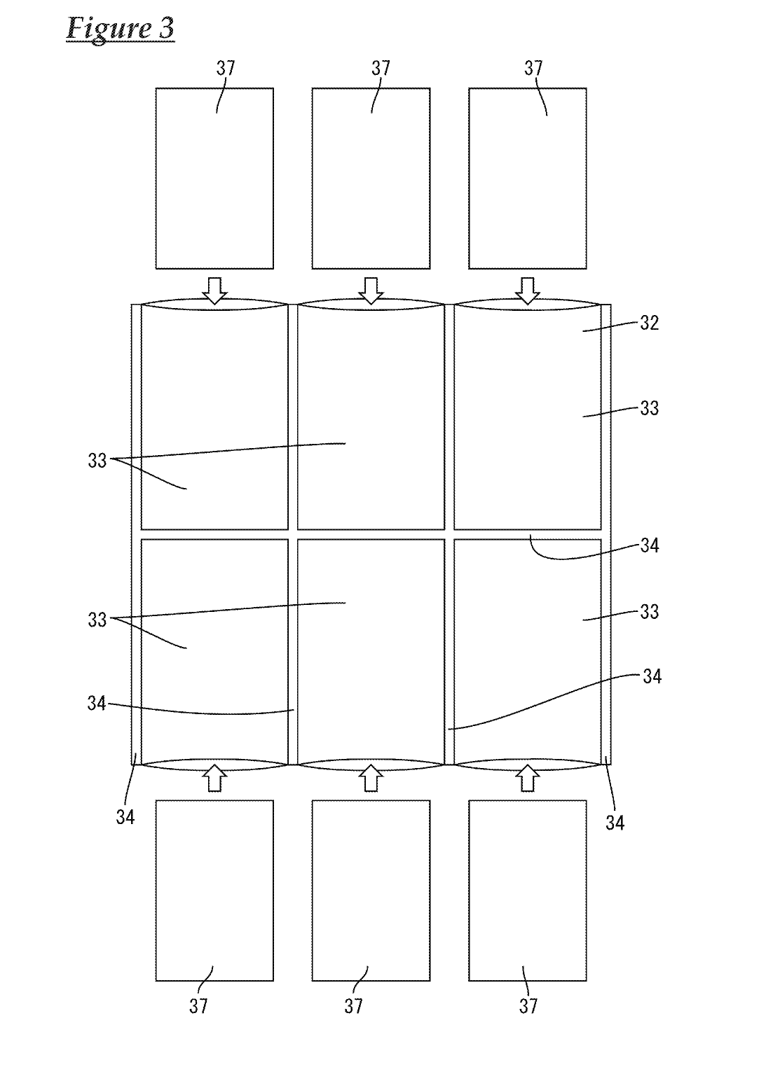

Next, as illustrated in FIG. 3, the absorbing member 37 is put in each small compartment 33. The absorbing member 37 is put in each of the three small compartments 33 at the front side of the sheet members 32 from the front edge and the absorbing member 37 is put in each of the three small compartments 33 at the rear side of the sheet members 32 from the rear edge.

Next, as illustrated in FIG. 4, the front edge portions of the three small compartments 33 formed at the front side of the sheet members 32 are bonded with heat-welding to form the bonded section 34 and seal the small compartments. Similarly, the rear edge portions of the three small compartments 33 formed at the rear side of the sheet members 32 are bonded with heat-welding to form the bonded section 34 and seal the small compartments. Thus, the cooling member 13 is formed.

Then, the power storage element 12 is disposed on the cooling member 13 such that the front edge portion and the rear edge portion of the cooling member 13 project outward from the front edge portion and the rear edge portion of the power storage element 12, respectively. Thus, the power storage module 10 is completed.

### (Operations and Effects of Embodiment)

Next, operations and effects of this embodiment will be described. According to this embodiment, the cooling member 13 includes the enclosing member 26 including the small compartments 33 while the sheet members 32 being bonded in a liquid tight manner, the refrigerant 27 enclosed within each of the small compartments 33, and the absorbing member 37 arranged in each of the small compartments 33 and absorbing the refrigerant 27. Each of the small compartments 33 includes the condensation section 40 where the refrigerant 27 that is in a gaseous state is condensed.

According to the above configuration, the enclosing member 26 is defined into the small compartments 33 and each small compartment 33 includes the condensation section 40. According to such a configuration, the refrigerant 27 that is condensed in the condensation section 40 and turned into liquid is absorbed by the absorbing member 37 and promptly spreads over a whole absorbing member 37. As a result, the absorbing member 37 is less likely to have the section that does not include the refrigerant 27 and is dry and the absorbing member 37 is less likely to have the section that does not work for cooling. Accordingly, the cooling efficiency of the cooling member 13 can be improved.

According to this embodiment, at least one absorbing member 37 is arranged in each of the small compartments 33.

According to the above configuration, at least one absorbing member 37 is arranged in each of the small compartments 33. Therefore, the size, material, shape, and the number of the absorbing members 37 arranged in each small compartment 33 can be designed for every small compartment 33. Accordingly, the cooling efficiency of the cooling member 13 can be improved.

The power storage module 10 according to this embodiment includes the cooling member 13 and the power storage element 12 including an outer surface at least a part of which is in contact with the cooling member 13.

According to the above configuration, the power storage element 12 can be cooled down effectively by the cooling member 13.

### Other Embodiments

The present technology described in this specification is not limited to the embodiment, which has been described using the foregoing descriptions and the drawings. For example, embodiments described below are also included in the technical scope of the present technology described in this specification.

Following configurations may be preferable for embodiments of the technology described in this specification.

At least one absorbing member may be arranged in each of the small compartments.

According to the above configuration, at least one absorbing member is arranged in each of the small compartments. Therefore, the size, material, shape, and the number of the absorbing members arranged in each small compartment can be designed for every small compartment. Accordingly, the cooling efficiency of the cooling member can be improved.

The technology described in this specification is a power storage module including the above cooling member, and a power storage element having an outer surface at least a part of which is in contact with the cooling member.

According to the technology described in this specification, the cooling efficiency of the cooling member can be improved.

In the above embodiment, one absorbing member 37 is arranged in each of the small compartments 33. However, it is not limited thereto and two or more absorbing members 37 may be arranged in each small compartment 33.

In the above embodiment, the small compartments 33 have a same shape and a same size. However, it is not limited thereto and the shape or the size of the small compartments 33 may be different.

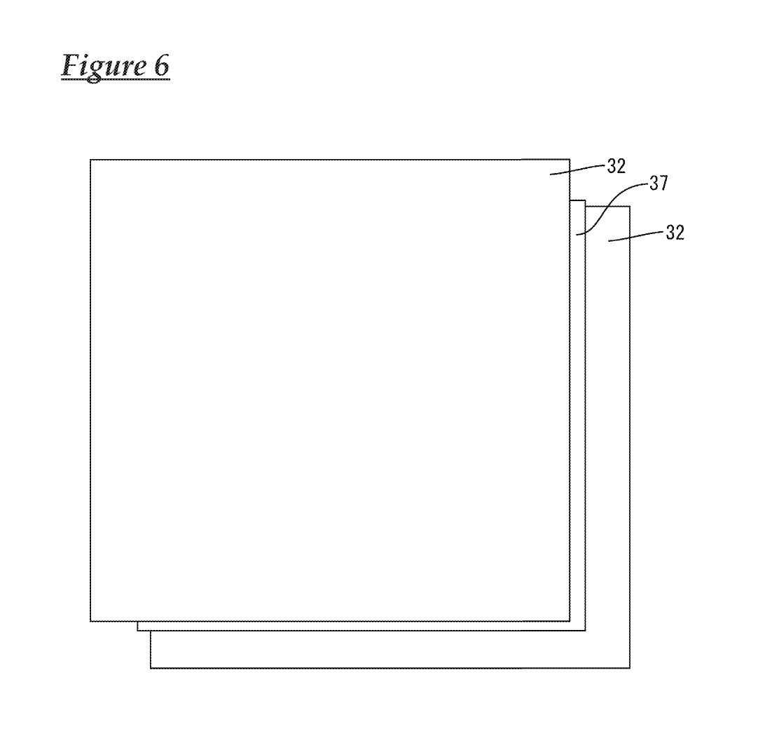

As illustrated in FIG. 6, the cooling member 13 may include one absorbing member 37 between the two sheet members 32, and the sheet members 32 and the absorbing member 37 may be bonded with heat-welding to have small compartments 33. According to this configuration, one absorbing member 37 includes sections each corresponding to each of the compartments 33 and each section of the absorbing member 37 is in the corresponding small compartment 33.

In the above embodiment, the cooling member 13 includes six small compartments 33. However, it is not limited thereto and one cooling member 13 may include two to five or seven small compartments or more.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### EXPLANATION OF SYMBOLS

10: power storage module
12: power storage element
13: cooling member
26: enclosing member
27: refrigerant
32: sheet member
33: small compartments
34: bonded section
37: absorbing member
40: condensation section

1. A cooling member comprising:
an enclosing member including sheet members connected in a liquid tight manner and including small compartments;
refrigerant enclosed in each of the small compartments; and
an absorbing member arranged in each of the small compartments and absorbing the refrigerant, wherein
each of the small compartments includes a condensation section where the refrigerant that is in a gaseous state is condensed.

2. The cooling member according to claim 1, wherein at least one absorbing member is arranged in each of the small compartments.

3. A power storage module comprising:
the cooling member according to claim 1; and
a power storage element having an outer surface at least a part of which is in contact with the cooling member.
